(19) United States
(12) Patent Application Publication
(10) Pub. No.: US 2024/0146169 A1
(43) Pub. Date: May 2, 2024

(54) FOCUS MOTOR WITH CLOSED-LOOP CONTROL METHOD AND CAMERA EQUIPMENT

(71) Applicant: CHIPSEMI SEMICONDUCTOR (NINGBO) CO., LTD., Ningbo (CN)

(72) Inventors: Yaoguo Zhang, Ningbo (CN); Bo Xia, Ningbo (CN); Yulin Zhang, Ningbo (CN)

(21) Appl. No.: 18/401,454

(22) Filed: Dec. 30, 2023

Related U.S. Application Data
(63) Continuation of application No. PCT/CN2022/099289, filed on Jun. 16, 2022.

(30) Foreign Application Priority Data
Jul. 27, 2021 (CN) 202110851784.9

(51) Int. Cl. H02K 41/02; G03B 13/34; H02K 11/00

(52) U.S. Cl. CPC H02K 41/02; G03B 13/34; H02K 11/0094

(57) ABSTRACT

The invention provides a focusing motor, a closed-loop control method for the focusing motor, and a camera device. The focusing motor includes a mover bracket and a mover plate mounted thereon, a stator and first stator plates and second stator plates mounted thereon, and a processing unit connected to the mover pole plate, the first stator plate and the second stator plate. The mover pole plate is positioned opposite the first stator plate and the second stator plate, and the facing areas change with the movement of the mover bracket. The processing unit controls the movement of the mover bracket in the focusing direction based on the capacitance signals formed by the mover pole plate and the first stator plate as well as the capacitance signals formed by the second stator plate.

### CROSS-REFERENCES TO RELATED APPLICATIONS

This application is a continuation of international application with application number PCT/CN2022/099289, filed on Jun. 16, 2022, which claims priority to Chinese patent application with application number 202110851784.9, filed on Jul. 27, 2021, the entire content of which is hereby incorporated by reference into this application.

### FIELD OF THE INVENTION

The invention described in this application relates to the field of camera technology, specifically involving a focus motor, a closed-loop control method for the focus motor, and a camera equipment employing the focus motor and the method.

### BACKGROUND OF THE INVENTION

With the advancement of camera technology, most camera modules in modern camera equipment typically use a closed-loop control method to achieve rapid and stable focusing. This method involves detecting the real-time position of the bracket supporting the mover or rotor within the focus motor during the focusing process. The driving current for the lens is then adjusted based on the detected position of the bracket, enabling it to swiftly reach the precise focus position.

There has been a prevailing trend toward miniaturization in focus motor technology, particularly in reducing the thickness of focus motors along their focusing axis. Furthermore, to enhance the focus range of these motors, it is imperative to extend the travel distance of the motor's mover bracket. However, a challenge arises when the travel distance of this mover bracket substantially exceeds its length in the focusing direction. In such scenarios, obtaining an electrical signal that accurately reflects the mover bracket's position becomes challenging at certain extended travel distances. This limitation hinders the achievement of effective closed-loop control in focus motors designed for extended travel.

### SUMMARY OF THE INVENTION

The present disclosure presents a focus motor design that includes a mover bracket capable of moving along the focus direction, a stator, a mover plate mounted on the bracket, and first and second fixed plates on the stator. In some embodiments, it also features a processing unit connected to these plates. The mover plate is positioned opposite to both fixed plates, with the lengths of these fixed plates in the focus direction being greater than that of the mover plate. The areas that face one another between the mover plate and each fixed plate change as the bracket moves. The processing unit moves the bracket in the focus direction based on the capacitance signals of the first and second capacitors, formed by the mover plate with each fixed plate, respectively.

This disclosure additionally provides a closed-loop control method for the focus motor. This method involves moving the mover bracket in the focus direction and then obtaining the first capacitance signal from the first capacitor and the second capacitance signal from the second capacitor. It assesses whether the bracket's position aligns with the target position. If they do not align, the bracket is adjusted to move again in the focus direction until its position matches the target position.

Additionally, the disclosure provides a camera device that includes a lens driven by the aforementioned focus motor.

The advantages of the invention will be apparent to those skilled in the art based on the following drawings and detailed descriptions.

### BRIEF DESCRIPTION OF THE DRAWINGS

One or more embodiments are exemplified through the images in the corresponding drawings. These illustrations do not limit the scope of the embodiments, and elements with the same reference numbers in the drawings are similar elements, unless specifically stated otherwise. The drawings are not necessarily to scale.

FIG. 1 shows a cross-sectional view along the focusing direction of an embodiment of a focus motor structure in accordance with the present disclosure.

FIG. 2 illustrates plate structure of various plates within a focus motor of an embodiment of the present disclosure.

FIG. 3 illustrates the plate structure of another embodiment of a focus motor in accordance with the present disclosure.

FIG. 4 presents the plate structure of yet another focus motor in accordance with the present disclosure.

FIG. 5 shows the plate structure of a further focus motor in accordance with the present disclosure.

FIG. 6 illustrates the plate structure of an additional focus motor in accordance with the present disclosure.

FIG. 7 is a diagram illustrating the parameters of various plates in a focus motor in accordance with the present disclosure.

FIG. 8 is a flowchart of illustrating an example closed-loop control method for a focus motor according to the present disclosure.

FIG. 9 is a flowchart illustrating an example process for assessing alignment with the target position according to the present disclosure.

FIG. 10 is a flowchart outlining illustrating an example process for establishing the relationship between position and capacitance values according to the present disclosure.

### DETAILED DESCRIPTION OF EMBODIMENTS

The purpose of this application's embodiment is to provide a focus motor, a closed-loop control method for the focus motor, and camera equipment. Specifically, the aim is achieving precise focus control in focus motors where the mover bracket has a relatively large movement range and a comparatively small thickness.

To make the objectives, technical solutions, and advantages of this application's embodiment clearer, a detailed explanation will be provided in conjunction with the accompanying drawings. However, it is understandable to those skilled in the art that numerous technical details are included in these embodiments to enhance the reader's understanding of the application. Despite this, the technical solutions sought to be protected by this application can still be realized, even without these technical details and through various alterations and modifications based on the following embodiments.

The various embodiments are categorized for ease of description and do not limit the specific implementations of this application. They can be combined and referenced interchangeably, provided there are no contradictions.

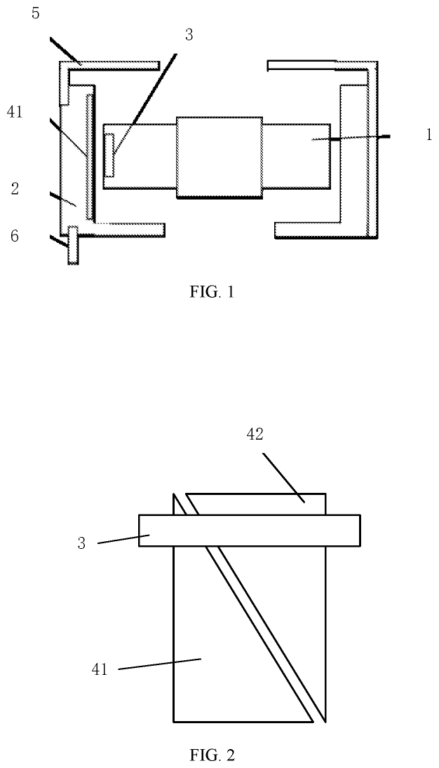

The present disclosure pertains to a focus motor, as depicted in FIGS. 1 and 2, comprising: a movable mover bracket 1, a stator 2, a mover plate 3 mounted on the bracket, first and second fixed plates 41 and 42 on the stator, and a processing unit connected to these components. The lengths of the fixed plates 41 and 42 in the focus direction are greater than the mover plate 3, with the facing areas between the mover plate 3 surface and that of each fixed plate changing as the bracket moves. The processing unit controls the bracket's movement in the focus direction based on the capacitance signals from the first and second capacitors, formed by the mover plate 3 with each fixed plate.

To control the movement of the mover bracket 1 in the focus direction using the capacitance signals of the first and second capacitors, the position of the mover bracket can be determined as stated in the following. First, if the capacitance signal of the first capacitor matches the signal obtained when the focus motor was in the target position during calibration, and similarly for the second capacitor, then the bracket aligns with the target position. In addition, by performing a logical operation on the capacitance values corresponding to the signals of the first and second capacitors, the bracket is then confirmed to be aligned if the result matches that obtained during pre-adjustment when the focus motor was in the target position. This logical operation on the signals enhances the differentiation of signals corresponding to different positions of the bracket, making it easier to determine its position based on the signals of the first and second capacitors.

The focus motors described above can be electromagnetic motors, piezoelectric motors, or shape memory alloy motors, but are not limited to these three types. Electromagnetic motors use the electromagnetic force of coils and magnets as the driving force, piezoelectric motors use the piezoelectric effect of ultrasonic piezoelectric ceramics, and shape memory alloy motors utilize the deformation characteristics of memory metals as the driving force.

In the embodiment depicted in FIGS. 1-2, the focus motor includes a mover bracket 1, a stator 2, a mover plate 3 on the bracket, and first and second fixed plates 41 and 42 on the stator. The fixed plates 41 and 42 are longer in the focusing direction than the mover plate 3. As the mover bracket 1 moves, the areas of the mover plate 3 that are directly opposite, or ‘facing,’ each fixed plate (41 or 42) shift accordingly. Due to the mover plate 3's relatively shorter length, the first and second capacitors—which are created between the mover plate 3 and each of the fixed plates 41 and 42—consistently undergo changes, regardless of the position to which the mover bracket 1 moves. This allows for precise real-time determination of the mover bracket 1's position, enabling closed-loop control of its movement to achieve focus.

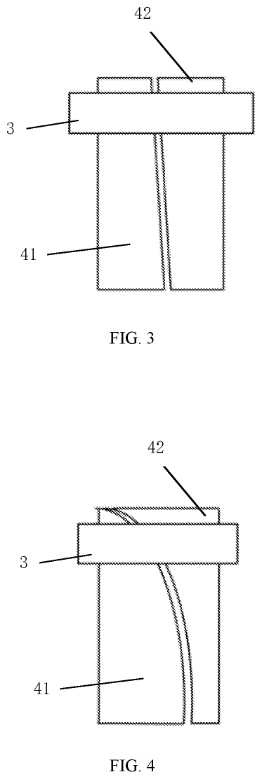

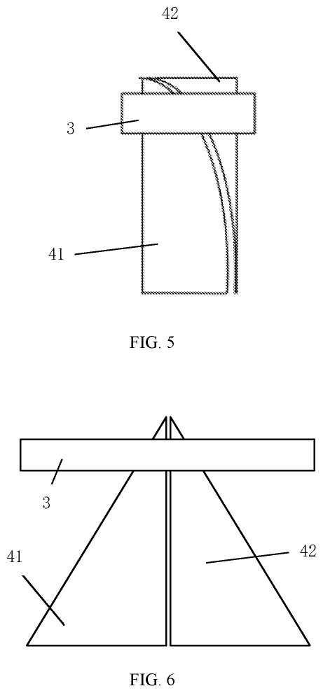

In certain embodiments, as illustrated in FIGS. 2 to 6, the areas facing the mover plate 3 and the first and second fixed plates 41 and 42 change monotonically with the movement of the mover bracket 1. This change can either be a monotonic increase or decrease. For instance, in FIGS. 2 to 5, as the mover plate 3 moves downward, its facing area with the first fixed plate 41 monotonically increases, while its facing area with the second fixed plate 42 monotonically decreases. Conversely, when the mover plate 3 moves upwards, the opposite occurs. The design is not limited to the shapes and sizes of the fixed plates 41 and 42 depicted in FIGS. 2-6.

The structure design of the first and second fixed plates 41 and 42 ensures that as the mover plate 3 moves, the capacitance signals formed at each position are distinct for both the first and second capacitors. This variance in capacitance values allows for the differentiation of the mover plate's position, thereby determining the position of the mover bracket 1. This setup simplifies the process of controlling the movement of the mover bracket 1 in the focus direction based on the capacitance signals of the first and second capacitors.

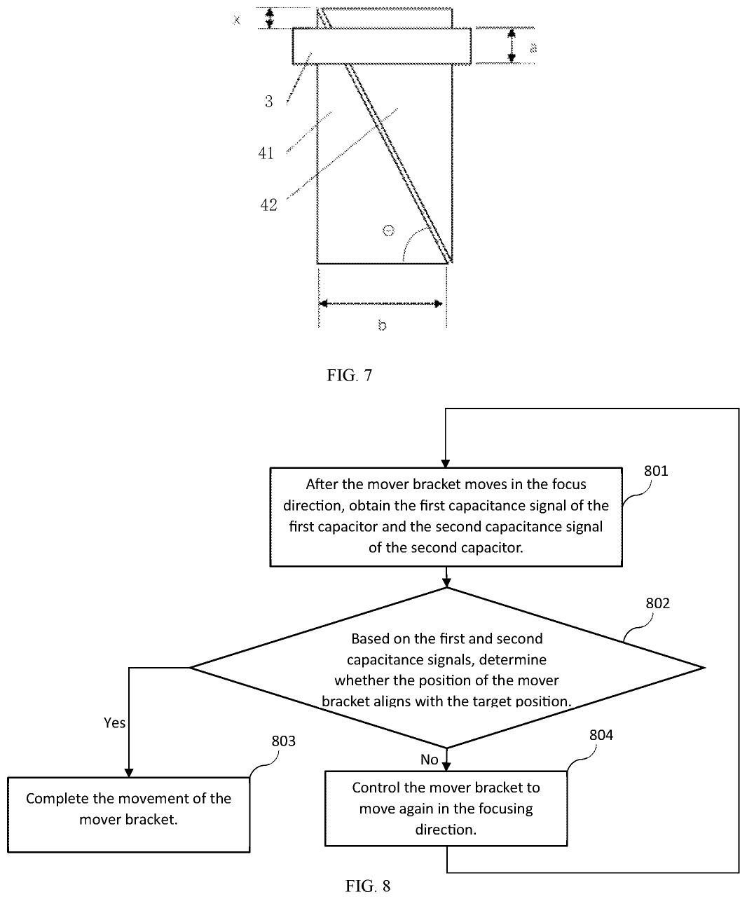

In some embodiments, the areas facing the mover plate 3 and the first and second fixed plates 41 and 42 change by the same amount as the mover bracket 1 moves. This further simplifies controlling the movement of the mover bracket 1 in the focusing direction based on the capacitance signals from the first and second capacitors. For further illustration, FIG. 7 shows the first and second fixed plates 41 and 42 as an example to explain how this approach simplifies the complexity of controlling the movement of the mover bracket 1.

Assuming in FIG. 7 that the length of the mover plate 3 in the focus direction is a, the length of the right-angle side of the first fixed plate 41 perpendicular to the focus direction is b, and the angle between the right-angle side and the hypotenuse of the first fixed plate 41 is θ. If the distance between the top surface of mover plate 3 length wise and the highest point of the first fixed plate 41 in the focus direction is x, then the facing area A between them is calculated as A=a·cot(θ)·(2x+a)/2, and the facing area B between the second fixed plate 42 and the mover plate 3 is B=a·[2b−cot(θ)·(2x+a)]/2. The difference A−B is linearly related to x when a and b is fixed, simplifying the complexity of controlling the movement of the mover bracket 1. Since the difference between facing area A and facing area B has a linear relationship with the movement distance x of the mover bracket, the difference in the capacitance signals of the first and second capacitors also has a linear relationship with the movement distance x. Compared to randomly generated capacitance signals, those with a linear relationship make it easier to determine the movement distance of the mover bracket, thereby further simplifying the complexity of controlling the movement of the mover bracket. If the shapes of the plates are irregular, the relationship between the capacitance signal and distance is nonlinear but can still allow determination of the movement of the bracket.

In some embodiments, the precision of determining the movement distance of the mover bracket 1 can be improved by adjusting the slope in the above calculations, controlling the extent of capacitance signal change. In particular, increasing the slope within a certain range can enhance accuracy.

In other embodiments, the first and second fixed plates 41 and 42 together form a rectangle.

In additional embodiments, the first and second fixed plates 41 and 42 are set in a centrally symmetric arrangement, facilitating mass production. The symmetry center is at the center of the rectangle formed by these plates. This symmetric setup regularizes the arrangement of the plates, allowing mass production.

In some embodiments, both the first and second fixed plates 41 and 42 can be right-angled triangles, but they are not limited to this shape. They can also be other regular or irregular shapes, as long as they meet the previously mentioned requirements regarding their design. There are no further restrictions on the shapes and sizes of the first and second fixed plates 41 and 42.

In some embodiments, the stator 2 specifically acts as a base. The first and second fixed plates 41 and 42 are set on this base either by directly attaching them to the corresponding areas and connecting them to the motor's internal wiring, or through embedded injection molding with metal parts in plastic components for direct molding, simplifying assembly. Alternatively, using Laser Direct Structuring (LDS) technology, selective surface laser activation and electroplating can create conductive areas, forming the fixed plates directly on the base.

Additionally, the first and second fixed plates 41 and 42 can also be integrated with the base through embedded injection molding or LDS technology, enhancing their attachment strength.

As shown in FIG. 1, in some embodiments, the processing unit (not shown) connects to the mover plate 3 and both fixed plates through motor pins 6, obtaining capacitance signals from the first and second capacitors via these pins 6.

In some embodiments, the focus motor also includes a lens, which is supported by the mover bracket 1.

Another embodiment of this application relates to a closed-loop control method for the focus motor, as illustrated in FIG. 8. The method involves the following steps:

Step 801, acquire the first capacitance signal from the first capacitor and the second capacitance signal from the second capacitor after the mover bracket starts moving in the focus direction.

Step 802, determine if the position of the mover bracket aligns with the target position based on these capacitance signals. If they align, proceed to step 803 to complete the movement of the bracket.

If they do not align, proceed to step 804, which involves continuing to move the bracket by increasing or decreasing the output drive current or voltage. Then the process returns to step 801 to repeat the acquisition and determination process until the position of the bracket aligns with the target, allowing progression to step 803 to complete the movement.

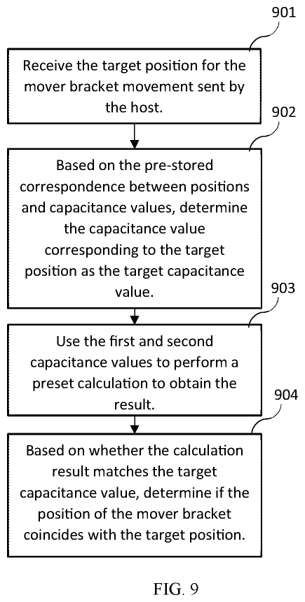

In some embodiments, when determining if the mover bracket's position aligns with the target position using the first and second capacitance signals, the specific steps are as shown in FIG. 9:

Step 901 is to receive the target position for the required movement of the mover bracket from the host.

Step 902 is determining the target capacitance value corresponding to the target position based on a pre-stored relationship between position and capacitance values.

Step 903 is then obtaining the first capacitance value corresponding to the first capacitance signal, and the second capacitance value corresponding to the second capacitance signal. These values are used for a preset calculation, which could be either an addition or subtraction operation, depending on the shapes and sizes of the first and second fixed plates.

Step 904 is to determine whether the mover bracket's position aligns with the target position based on whether the calculation result matches the target capacitance value. If they match, the position of the bracket aligns with the target position.

In some embodiments, closed-loop control is achieved through a control chip, which includes a capacitance detection circuit, an analysis and calculation circuit, and a control output circuit. The capacitance detection circuit detects the capacitance signal formed by the plates. The analysis and calculation circuit decides whether to move the mover based on the capacitance signal and calculates the required drive current (or voltage). The control output circuit then delivers the calculated drive current (or voltage) to the motor, controlling the movement of its mover bracket.

In some embodiments, after moving the motor's mover bracket, the capacitance signal changes, prompting the control chip to reanalyze and recalculate based on the updated signal. This process continues until the bracket's position aligns with the target, completing the motor control.

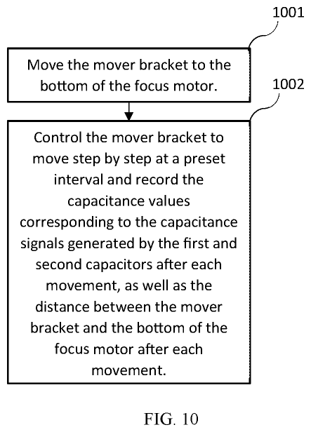

The process for establishing the pre-stored relationship between position and capacitance values in Step 902, as illustrated in FIG. 10, includes:

Step 1001, in which, the mover bracket is moved to the bottom of the focus motor.

Step 1002 where the mover bracket is controlled to move in predetermined intervals. After each movement, the capacitance values corresponding to the capacitance signals of the first and second capacitors and the distance between the mover bracket and the bottom of the focus motor are recorded. The relationship between the position of the mover bracket after each movement and the corresponding capacitance values of the first and second capacitors is established as the relationship between position and capacitance values.

The division of steps in these methods is for clarity of description. In implementation, they can be combined into one step or further divided into multiple steps, as long as they maintain the same logical relationship. Any minor modifications or non-essential additions to the algorithm or process that do not change its core design are within the scope of this patent.

Another embodiment of this application pertains to a camera device, comprising a lens and the aforementioned focus motor for driving the lens.

Compared to related technology, the camera device in this embodiment includes the focus motor as described in previous embodiments, thus offering the same technical advantages, which are not repeated here for brevity.

Those skilled in the art will understand that the above embodiments are specific implementations of this application, and various modifications can be made in form and detail in actual applications without departing from the spirit and scope of this application.

What is claimed is:

1. A focus motor, comprising:
a mover bracket,
a stator,
a mover plate mounted on the mover bracket,
a first fixed plate and a second fixed plate mourned on the stator, and
a processing unit connected to the mover plate, the said first fixed plate, and the said second fixed plate;
wherein the mover bracket is movable along the focus direction, the mover plate being oppositely set to both the first and the second fixed plates, and the lengths of the first and the second fixed plates in the focus direction are greater than the length of the mover plate in the same direction.

2. The focus motor of claim 1, wherein a first capacitor is formed between the mover plate and the first fixed plate, and the second capacitor is formed between the mover plate and the second fixed plate, and the processing unit controls the movement of the mover bracket in the focus direction based on the capacitance of the first and second capacitors.

3. The focus motor of claim 1, wherein the facing areas between the mover plate and the first and second fixed plates change monotonically with the movement of the mover bracket.

4. The focus motor of claim 3, wherein when the facing area between the mover plate and the first fixed plate increases, the area facing the second fixed plate decreases.

5. The focus motor of claim 3, wherein when the facing area between the mover plate and the first fixed plate decreases, the area facing the second fixed plate increases.

6. The focus motor of claim 1, wherein shape of the first and shape of the second fixed plate together form a rectangle.

7. The focus motor of claim 1, wherein the changes in the facing areas between the mover plate and both the first and second fixed plates are equal as the mover bracket moves.

8. The focus motor of claim 1, wherein the shapes and sires of the first and second fixed plates are the same.

9. The focus motor of claim 1, wherein the stator is a base, and the first and second fixed plates are integrated with the base through embedded injection molding.

10. A closed-loop control method for a focus motor comprising a mover bracket, a stator, a mover plate mounted on the mover bracket, a first fixed plate and a second fixed plate mounted on the stator, and a processing unit connected to the mover plate, the said first fixed plate, and the said second fixed plate, wherein the method is being implemented by the processing unit and comprises:
after the mover bracket starts moving in the focus direction, acquiring a first capacitance signal from the first capacitor and a second capacitance signal from the second capacitor;
determining whether the position of the mover bracket aligns with the target position based on the first capacitance signal and second capacitance signal; and
if not aligning, controlling the mover bracket to move again in the focus direction until the position of the bracket aligns with the target position.

11. The method of claim 10, wherein the determining whether the position of the mover bracket aligns with the target position based on the first and second capacitance comprises:
determining the target capacitance corresponding to the target position based on a pre-stored relationship between position and capacitance value;
obtaining a first capacitance value corresponding to the first capacitance signal, and a second capacitance value corresponding to the second capacitance signal;
performing a preset calculation using the first capacitance value and the second capacitance value to Obtain a result;
determining whether the position of the mover bracket aligns with the target position by comparing the calculation result with the target capacitance value.

12. A camera device, comprising: a lens, and a focus motor for driving the lens, wherein the focus motor comprises a mover bracket, a stator, a mover plate mounted on the mover bracket, a first fixed plate and a second fixed plate mounted on the stator, and a processing unit connected to the mover plate, the said first fixed plate, and the said second fixed plate; wherein the mover bracket is movable along the focus direction, the mover plate being oppositely set to both the first and the second fixed plates, and the lengths of the first and the second fixed plates in the focus direction are greater than the length of the mover plate in the same direction.
